(19) United States
(12) Patent Application Publication
(10) Pub. No.: US 2004/0219349 A1
(43) Pub. Date: Nov. 4, 2004

(54) Manufacturing of self-contained imaging assembly for identification card applications

(76) Inventors: Bradley A. Paulson, Northfield, MN (US); Darren W. Haas, Bloomington, MN (US); I. Tony Haugen, Minnetonka, MN (US); Robert J. Innes, Savage, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/797,636

(22) Filed: Mar. 10, 2004

Related U.S. Application Data
(60) Provisional application No. 60/453,376, filed on Mar. 10, 2003.
(60) Provisional application No. 60/453,377, filed on Mar. 10, 2003.

(51) Int. Cl. G03C 1/76; B32B 3/26

(52) U.S. Cl. 428/321.1; 430/270.1

(57) ABSTRACT

The card includes first support, second support, and imaging layer intermediate the first and second supports. The second support is sealed to the first support. And, the imaging layer includes photosensitive microcapsules that are activated by cylithographic photography to produce an identification card image. Additionally, the identification card includes one or more of the following: (a) an anti-static coating that is applied to the second support on the side opposite the imaging side; (b) magnetic recording media on the second support on the side opposite the imaging side; (c) electronics incorporated into the second support that enables contact or contactless radio frequency access control; (d) a pressure sensitive adhesive or a thermo set adhesive to bond the second support to the imaging layer; (e) an adhesive that is coated onto the second support or the imaging layer prior to sealing the second support to the first support, etc.

### CLAIM TO PRIORITY

The present application claims priority to U.S. Provisional Application No. 60/453,376, filed Mar. 10, 2003 and entitled, “Support for Self-Contained Imaging Assembly having Improved Peel Strength” and to U.S. Provisional Application No. 60/453,377, filed Mar. 10, 2003, and entitled, “Manufacturing of Self-Contained Imaging Assembly for Identification Card Applications.” Each of the identified provisional patent applications is hereby incorporated by reference.

### FIELD OF THE INVENTION

The present invention relates to self-contained imaging assemblies and, more particularly, to self-contained imaging assemblies specific to identification card applications.

### BACKGROUND OF THE INVENTION

Self-contained imaging assemblies are described in U.S. Pat. Nos. 4,440,846, 5,783,353, 6,037,094, 6,127,084, and 6,387,585, each of which is hereby incorporated by reference. Each discloses a self-contained imaging assembly wherein a layer of microcapsules containing a chromogenic material and a photohardenable or photosoftenable composition, and a developer that may be in the same or a separate layer from the microcapsules, is image-wise exposed. When image-wise exposed, the microcapsules rupture and an image is produced by the differential reaction of a chromogenic material and the developer. U.S. Pat. No. 5,783,353 more specifically discloses a self-contained media in which the photosensitive microcapsules and the developer are sealed between two plastic films such that the user never comes into contact with the chemicals, which form the image unless the media is deliberately destroyed. U.S. Pat. No. 6,387,585 (hereafter, the '585 patent) more specifically discloses a self-contained media in which the photosensitive microcapsules and the developer are sealed between two plastic films with an increased resistance to peeling by addition of specific adhesion promoters.

In the self-contained imaging system of the '585 patent, the imaging layer comprises a developer, photohardenable microcapsules and an adhesion promoter. The imaging layer is sealed between two support members to form an integral unit having improved peel strength. This sealed format is advantageous because it prevents the developer material and the contents of the microcapsules from contacting persons during handling and, depending on the nature of the supports, it may also prevent oxygen from permeating into the photohardenable material which may improve film speed and the stability of the image. The term “sealed” as used herein refers to a seal which is designed as a non-temporary seal which results in destruction of the imaging assembly if the seal is broken. Adhesion promoters used in accordance with the '585 disclosure increase cohesion and adhesion within and between the layers of the composite imaging sheet to produce an imaging system having improved peel strength. The peel strength provides an indication of the integrity of the composite, self-contained imaging system. Increasing the peel strength of the imaging system insures that the benefits associated with having a sealed system are not compromised.

In the imaging assembly of the '585 patent, the previously mentioned first support is transparent and the second support may be transparent or opaque. In the latter case, an image is provided against a white background as viewed through the transparent support and in the former case a transparency is provided in which the image is viewed as a transparency preferably using an overhead or slide projector. Sometimes herein the first support may be referred to as the “front” support and the second support may be referred to as the “back” support.

To ensure that the imaging system of the '585 patent is effectively sealed between the supports, a subbing layer is provided between the supports, a subbing layer is provided between one of the supports and the imaging layer, and an adhesive is provided between the other support and the imaging layer. For optical clarity, the subbing layer is typically located between the first support and the imaging layer. However, which support receives the subbing layer and which support receives the adhesive is a function of which support is coated with the wet imaging layer composition and which is assembled with the coated and dried imaging layer. The support which is coated with the imaging layer composition (which is typically the front support) will be provided with the subbing layer and the support which is assembled with the dried imaging layer will receive the adhesive.

Further with regard to the '585 patent, the use of an imaging layer containing both the microcapsules and the developer is desirable because the image is formed in direct contact with the front transparent support through which the image is viewed. It has been found that this provides better image quality than, for example, providing a developer layer which overlies a separate layer of microcapsules, because the assembly can be exposed and viewed from the same side, the image can be viewed against a white background (when the back support is opaque) and, the image lies directly under the support through which it is viewed where it is most intense.

Cylithographic Digital Photography

The above-described, prior art construction is intended for photographic applications and, as such, presents a significantly thinner gauge and a substantially lower adhesion component than would be required for a card application, e.g., an identification card. A thicker gauge and higher adhesion components must be met in order to meet the specifications of data interchange documents, such as identification cards. This is done through a process called cylithographic digital photography for ID card production.

Digital cylithographic photography provides for printed data to be contained within the surface of the card, under a durable, protective coating, yielding a secure and reliable identification card. The system produces photographic quality prints without using ribbons or ink cartridges.

Presently, most photo identification cards are printed by digital thermal transfer, where a single use ribbon, carrying transferable ink or a dye in a polymeric binder, is heated from behind with a thermal print head (TPH), while in contact with a receptive surface. In mass transfer thermal printing, as each pixel heats the ribbon, the ink adheres and transfers to the receptive surface. A ribbon carrying a dye in a polymeric binder is used for dye diffusion thermal transfer, D2T2, and, as each pixel heats, the dye melts and diffuses from the ribbon, into a vinyl, or PVC, surface. Printing with successive yellow, magenta, and cyan panels across the substrate, creates a three-color image in the surface. However, in thermal transfer printing, since the efficiency of transferring the ink or dye from the heated pixel to the surface of the card depends on close, intimate contact, the presence of dirt, debris, or surface imperfections, will preclude contact of the ribbon with the surface, leaving corresponding voids and vacancies in the printed image.

Capitalizing on success in home/office applications, identification card printers using ink-jet technology have been introduced. While ink-jet printing can be continuous, primarily for monochrome, or drop-on-demand (DOD), printing aqueous or solvent-based inks or dyes with either thermal or piezo print heads, the basis of ink-jet printing is the formation and expulsion of colorant drops through an orifice, which impact the receptive surface to form a printed image. Since the print heads do not contact the receptive surface, dirt, debris, and surface imperfections do not degrade the quality of the printed image, directly. However, the presence of dirt and debris during printing blocks transfer of the ink to the surface, leaving voids in the printed image when it is removed.

To print to hard, plastic identification cards with either thermal transfer or ink-jet printing, the apparent quality of the printed image frequently depends on the ability of the mechanical printer systems to accurately register each of the printing sequences, yellow, magenta, cyan, and black, and to smoothly move the substrate and ribbon beneath the TPH or substrate beneath the ink-jet print head during the print sequences. Frequently, increasing the printing speed is accomplished by reducing the resolution of the printed image and, conversely, increasing the resolution is accomplished by reducing the printing speed. Furthermore, since the printed information is on, or in, the exposed, printed surface, protective films are frequently required to prevent damage to the printing.

Cylithography incorporates the colorant in the media, eliminating the transfer of colorant from a print ribbon or an ink reservoir to the printing surface. In Cylithography, the dye precursors are contained in microcapsules approximately 4 to 10 microns in diameter, called Cyliths, each color segregated in separate Cyliths. The walls of the Cyliths contain photo initiators, with each color precursor, cyan, magenta, and yellow, having different spectral sensitivity. When exposed to light of an active bandwidth, the photo initiator induces polymerization of monomers in the capsules, hardening the capsules and trapping the leuco dyes within the capsules. Since the printing process is photographic, relying on light exposure rather than ink transfer, printing speed is limited by the intensity of the source.

After exposing the media to a predetermined light mix and intensity, the media is pressurized to squeeze the leuco dyes from the Cyliths. The leuco dyes then react with the receiver resin surrounding the capsules to produce the intended color. If a capsule is filly exposed and hardened, no dye will come out from the capsule and no color will be seen. If the media is exposed to red light only, the cyan capsules will harden, so that only the magenta and yellow capsules release dyes when developed, producing a red color. Likewise, if the media is exposed to green light only, the magenta Cyliths harden, releasing cyan and yellow during development, producing a green color. Similarly, if the media is exposed to blue light only, the yellow Cyliths harden, leaving the cyan and magenta dyes to form a blue color. Thus, with a combination of three primary colors at full exposure strength, eight colors can be presented. Since hardening of the Cyliths takes place in an analog and continuous fashion according to the amount of light the capsules receive, the amount of dyes released from the capsules changes continuously, allowing expression of the full gray scale.

Since the colorants are already present in the surface, print speed no longer relies on transfer from a reservoir to the surface, and so, print quality and print speed are no longer directly related. Print speed is entirely dependent on the mechanism required to expose the surface to light in a controlled manner. As with conventional photography, the surface can be exposed in a single flash, or with a scanning mechanism, similar to conventional thermal transfer or ink-jet printing. Furthermore, since the dye precursors are already present in the surface of the substrate, the perceived quality of the printed image fundamentally depends on the exposing mechanism. Again, as with conventional photography, the surface can be exposed to a projected image, or with a scanning mechanism such as is used in conventional thermal transfer or ink-jet printing.

As noted earlier, identification cards produced by conventional thermal transfer and ink-jet printing leave the printed data at, or diffused into, the surface of the card. Therefore, a protective layer is frequently applied over the printed, receptive surface, to protect the surface from environmental exposure, effectively sealing the dyes and inks within the surface. During manufacture, the cylithographic layer is coated on a transparent polyester film and then laminated to an opaque core. Thus, the card is constructed with the cylithographic layer already sealed under a clear overlaminate.

Digital cylithographic photography provides for printed data to be contained within the surface of the card, under a durable, protective coating, yielding a secure and reliable identification card. The system produces photographic quality prints without using ribbons or ink cartridges. An example of a digital cylithographic printer may be found in co-pending U.S. patent application Ser. No. 10/677,762, filed Oct. 2, 2003, and entitled “Card Printing System and Method”; the identified pending patent application is hereby incorporated by reference.

### SUMMARY OF THE INVENTION

The limitations above are in large part addressed by an identification card of the present invention. The identification card includes a first support, a second support, and an imaging layer intermediate the first and second supports. The second support is sealed to the first support. And, the imaging layer includes photosensitive microcapsules that are activated by cylithographic photography to produce an identification card image. Additionally, the identification card includes one or more of the following: (a) an anti-static coating that is applied to the second support on the side opposite the imaging side; (b) magnetic recording media on the second support on the side opposite the imaging side; (c) electronics incorporated into the second support that enables contact or contactless radio frequency access control; (d) a pressure sensitive adhesive or a thermo set adhesive to bond the second support to the imaging layer; (e) an adhesive that is coated onto the second support or the imaging layer prior to sealing the second support to the first support; and (f) an unsupported adhesive that is sealed between the second support and the first support carrying the imaging layer.

The present invention also provides for a method for manufacturing an identification card including the steps of: (a) presenting a first support; (b) applying an imaging layer to the first support (the imaging layer includes photosensitive microcapsules); (c) applying a second support to the imaging layer; (d) sealing the second support to the first support; (e) activating the photosensitive microcapsules to produce an identification card image; and one or more of the following: (1) applying an anti-static coating to the second support on a side opposite the imaging layer; (2) applying magnetic recording media to the second support on a side opposite the imaging layer; (3) incorporating electronics into the second support (electronics enable contact or contactless radio frequency access control of the identification card); (4) bonding the second support to the imaging layer with a pressure sensitive or thermo set adhesive; (5) coating the second support or the imaging layer with an adhesive prior to the step of sealing the second support to the first support; and (6) supplying an adhesive between the second support and the first support carrying the imaging layer, prior to sealing the second support to the first support.

### BRIEF DESCRIPTION OF THE DRAWINGS

FIG. 1 depicts that layers the form that self-contained imaging system of the present invention.

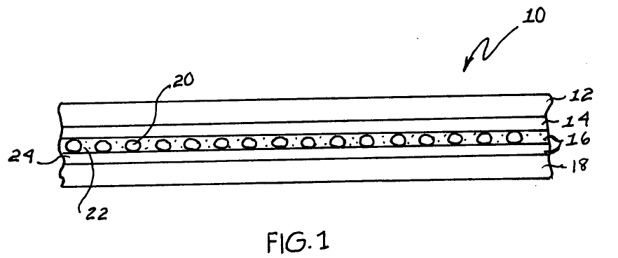

### DETAILED DESCRIPTION OF THE PREFERRED EMBODIMENTS

In the self-contained imaging system of the present invention, the imaging layer is sealed between two support members to form an integral unit meeting the requirements of data interchange documents, typically identification cards suitable for cylithographic photography processes. The sealed format is advantageous because it prevents the developer material and the contents of the microcapsules from contacting persons during handling and, depending on the nature of the supports, it enables incorporation of additional features in the support such as anti-static coatings to facilitate media transport during printing, contact or contactless IC functionality and magnetic stripes for final applications.

To record images, the imaging material can be scanned with an LED print head and developed by application of pressure to the unit. An image appears on the face of the unit. The media can be printed using a printer which incorporates an LED print head in combination with one LED/developer head of the type described in U.S. Pat. No. 5,550,627, which is hereby incorporated by reference. Of course, the media can be exposed and developed using any of the exposure and developing equipment that is taught in the art as it relates to imaging materials employing photosensitive microcapsules of this type, e.g., laser scan, LCD, laser-addressed LCD, reflection imaging, etc. Other development devices such as pressure roller development could be used. However, the preferred manner of activating the photosensitive microcapsules is through use of a digital cylithographic printer, see for example U.S. patent application Ser. No. 10/677,762, filed Oct. 2, 2003, and entitled “Card Printing System and Method”, hereby incorporated by reference.

As such, in accordance with the preferred embodiment of the invention, a self-contained imaging system 10 in the form of a cylithographic photography-ready identification card comprises in order: a first transparent support 12, a subbing layer 14 between the first transparent support 12 and an imaging layer 16, and a second support 18 that may or may not contain an opacifying agent. The imaging layer 16 comprises an imaging composition comprising photohardenable microcapsules 20 and a developer material 22, and a layer of adhesive 24 to bond the imaging layer 16 to the second support 18.

Images are formed in the present invention in the same manner as described in U.S. Pat. No. 4,440,846, which is hereby incorporated by reference. By image-wise exposing this unit to actinic radiation, the microcapsules are differentially hardened in the exposed areas as taught in U.S. Pat. No. 4,440,846. The exposed unit is subjected to pressure to rupture the microcapsules.

The identification card after exposure and rupture of the microcapsules forms an image. The ruptured microcapsules release a color forming agent, whereupon the developer material 22 reacts with the color forming agent to form the image. The image formed is viewed through the transparent support 12 against the support 18 which can contain a white pigment. Typically, the microcapsules consist of three sets of microcapsules sensitive respectively to red, green and blue light and containing cyan, magenta and yellow color formers, respectively, as taught in U.S. Pat. No. 4,772,541, which is hereby incorporated by reference. Also useful in the present invention is a silver-based photohardenable microencapsulated system such as that described in U.S. Pat. Nos. 4,912,011; 5,091,280, and 5,118,590 (all of which are hereby incorporated by reference) and other patents assigned to Fuji Photo Film Co. A direct digital transmission imaging technique may be employed, using a digital cylithographic printer as mentioned above.

Imaging layer 16 typically contains about 20 to 80% (dry weight) of the developer, about 80 to 20% (dry weight) microcapsules, about 0 to 20% (dry weight) binder and about 0.01 to 10%, preferably 0.5 to 5% of an adhesion promoter. The layer is typically applied in a dry coat weight of about 8 to 20 g/m². Binder materials that may be utilized include polyvinyl alcohol, polyacrylamide, and acrylic lattices.

In the cylithographic identification card, the first transparent support 12 through which the image is viewed can be formed from any transparent polymeric film. A film is selected that provides good photographic quality when viewing the image. Preferably, a film is used that is resistant to yellowing. The first support 12 is typically a transparent polyethylene terephthalate (PET) support.

The second support 18 is preferably an opaque support such as polyethylene terephthalate (PET) containing an opacifying agent, paper or paper lined with film (polyethylene, polypropylene, polyester, etc.). Most preferably, the opaque support is a polyethylene terephthalate support containing about 10% titanium dioxide which provides a bright white opaque support. This support is commercially available from ICI, Ltd. under the product designation Melinex®. Typically, the laminated structure will have a thickness of 0.030+/−0.003 inches, to meet the requirements of ISO/IEC 7810 Identification Cards—Physical Characteristics, but the thickness can be altered to meet the requirements of the application.

Generally, the opaque support is available commercially. Some other products which are useful include paper cardboard, polyethylene, polyethylene-coated paper, etc. Opaque films are composites or admixtures of the polymer and the pigment in a single layer, films or coated papers. Alternatively, the opacifying agent can be provided in a separate layer underlying or overlying a polymer film such as PET. The opacifying agent employed in these materials is an inert, light-reflecting material that exhibits a white opaque background. Materials useful as the opacifying agent include inert, light-scattering white pigments such as titanium dioxide, magnesium carbonate or barium sulfate. In a preferred embodiment, the opacifying agent is titanium dioxide.

In a preferred embodiment of the cylithographic identification card, the second support 18 includes an anti-static coating on the side opposite the imaging layer, to facilitate transport of the self-contained imaging media through a printing apparatus. In alternative embodiments of the invention: the second support 18 possesses magnetic recording media on the side opposite the imaging layer, to enable the use of the self-contained imaging media with a magnetic stripe reader/writer; the second support 18 includes the components necessary for contact or contactless IC applications including, but not limited to, an antenna coil and circuitry for contactless RF access control; the second support 18 is bonded to the imaging layer with a pressure sensitive adhesive (preferred examples include but are not limited to AROSET® 1860-Z-45 available from Ashland Specialty Chemical Company); the second support 18 is bonded to the imaging layer with a thermoset adhesive (preferred examples include, but are not limited to, W11, W35, and W60 polyester-urethane adhesives from Waytek Corporation); the adhesive is coated on the second support 18 prior to lamination of the second support to the first support carrying the imaging layer; the adhesive is coated on the imaging layer prior to lamination of the second support to the first support carrying the imaging layer; and the adhesive is an unsupported adhesive and is laminated between the second support and the first support carrying the imaging layer.

In a preferred embodiment, the imaging layer of the present invention is employed in the construction of a two-sided imaging material in accordance with U.S. Pat. No. 6,037,094, which is hereby incorporated by reference. The two-sided imaging material comprises a pair of transparent supports, an opaque support and an imaging layer disposed between each transparent support and the opaque support. The benefits provided by the imaging layer of the present invention are particularly useful in a two-sided imaging material. Adhesion and cohesion characteristics of the composite coating are believed to be more important in a two-sided imaging material because of the additional layers involved in the construction of the imaging assembly.

In a preferred embodiment of the invention, the cylithographic identification card is exposed to light prior to cutting in such a manner that the cut edge has been exposed to prevent development along the cut edge. In a further preferred embodiment, exposure of the media prior to cutting minimizes the area of the final product that has been exposed to light.

In a preferred embodiment of the invention, the cylithographic identification card has a contact IC chip inserted, according to the specifications of ISO/IEC 7816 Identification Cards-Integrated Circuit(s) cards with contacts.

In accordance with one embodiment of the invention, a full color imaging system 10 is provided in which the microcapsules are in three sets respectively containing cyan, magenta and yellow color formers sensitive to red, green, and blue light, respectively. However, digital imaging systems do not require the use of visible light and as such, sensitivity can be extended into the UV and IR. For optimum color balance, the visible-sensitive microcapsules are sensitive (.lambda.max) at about 450 nm, 540 nm, and 650 nm, respectively. Such a system is useful with visible light sources in direct transmission or reflection imaging. Such a material is useful in making contact prints, projected prints of color photographic slides, or in digital printing. They are also useful in electronic imaging using lasers or pencil light sources of appropriate wavelengths.

The photohardenable composition in at least one and possibly all three sets of microcapsules can be sensitized by a cationic dye-borate complex as described in U.S. Pat. No. 4,772,541, which is hereby incorporated by reference. Because the cationic dye-borate anion complexes absorb at wavelengths greater than 400 nm, they are colored and the unexposed dye complex present in the microcapsules in the non-image areas can cause undesired coloration in the background area of the final picture. Typically, the mixture of microcapsules is greenish and can give the background areas a greenish tint. Means for preventing or reducing undesired coloration in the background as well as the developed image include reducing the amount of photoinitiator used and adjusting the relative amounts of cyan, magenta and yellow microcapsules. In this regard it is desirable to include a disulfide compound in the photosensitive composition to reduce the amount of dye-borate that may be required as described in detail in U.S. Pat. No. 5,783,353, which is hereby incorporated by reference.

The photohardenable compositions of the present invention can be encapsulated in various wall formers using techniques known in the area of carbonless paper including coacervation, interfacial polymerization, polymerization of one or more monomers in an oil, as well as various melting, dispersing, and cooling methods. To achieve maximum sensitivities, it is important that an encapsulation technique be used which provides high quality capsules which can be differentially ruptured based upon changes in the internal phase viscosity. Because the dye-borate tends to be acid sensitive, encapsulation procedures conducted at higher pH (e.g., greater than about 6) are preferred.

Melamine-formaldehyde capsules are particularly useful. It is desirable in the present invention to provide a pre-wall in the preparation of the microcapsules. See U.S. Pat. No. 4,962,010, which is hereby incorporated by reference, for a particularly preferred encapsulation using pectin and sulfonated polystyrene as system modifiers. The formation of pre-walls is known, however, the use of larger amounts of the polyisocyanate precursor is desired. A capsule size should be selected which minimizes light attenuation. The mean diameter of the capsules used in this invention typically ranges from approximately 1 to 25 microns. As a general rule, image resolution improves as the capsule size decreases. Technically, however, the capsules can range in size from one or more microns up to the point where they become visible to the human eye.

The developer materials and coating compositions containing the same conventionally employed in carbonless paper technology are useful in the present invention. Illustrative examples are clay minerals such as acid clay, active clay, attapulgite, etc.; organic acids such as tannic acid, gallic acid, propyl gallate, etc.; acid polymers such as phenol-formaldehyde resins, phenol acetylene condensation resins, condensates between an organic carboxylic acid having at least one hydroxy group and formaldehyde, etc.; metal salts of aromatic carboxylic acids or derivatives thereof such as zinc salicylate, tin salicylate, zinc 2-hydroxy napththoate, zinc 3,5 di-tert butyl salicylate, zinc 3,5-di-(a-methylbenzyl) salicylate, oil soluble metals salts or phenol-formaldehyde novolak resins (e.g., see U.S. Pat. Nos. 3,672,935 and 3,732,120, which are hereby incorporated by reference) such as zinc modified oil soluble phenol-formaldehyde resin as disclosed in U.S. Pat. No. 3,732,120, zinc carbonate etc., and mixtures thereof. The preferred developer material is one which will permit room temperature development such as zinc salicylate and particularly a mixture of zinc salicylate with a phenol formaldehyde resin. Especially preferred for use, is a mixture of zinc salicylate or a zinc salicylate derivative and phenol-formaldehyde resin and, more particularly, a mixture of 25% HRJ 11177, a phenolic resin from Schenectady Chemical Company and 75% zinc salicylate. The particle size of the developer material is important to obtain a high quality image. The developer particles should be in the range of about 0.2 to 3 microns and, preferably in the range of about 0.5 to 1.5 microns.

A preferred developer material is one that has excellent compatibility with the microcapsule slurry solution. Many materials, including zinc salicylate and some phenolic resin preparations, have marginal or poor compatibility with the MF microcapsule preparation and result in agglomeration which is believed to be due to an incompatibility in the emulsifiers used in preparing the microcapsules and in the developer. The problem manifests itself in increasing solution viscosities or in instability of the microcapsules wall (or both). The microcapsules may become completely disrupted with a complete breakdown or disintegration of the wall. The problem is believed to be caused by the presence of water soluble acid salts in the developer solution. By modifying the acidic salts to make them water insoluble the developer material becomes compatible with the MF microcapsules. Examples of preferred developers which have good stability with MF microcapsules include HRJ-4250 and HRJ-4542 available from Schenectady International.

A suitable binder such as polyethylene oxide, polyvinyl alcohol (PVA), polyacrylamide, acrylic lattices, neoprene emulsions, polystyrene emulsions and nitrile emulsions, etc., may be mixed with the developer and the microcapsules, typically in an amount of about 1 to 8% by weight, to prepare a coating composition.

The use of appropriate dispersing agents can enhance the adhesion performance of the adhesion promoters of the present invention. This synergistic effect is particularly evident when the dispersing agents are used in conjunction with phenylcoumarin adhesion promoters. Materials that can be used as dispersants in the present invention include partially and fully hydrolyzed polyvinyl alcohol, polyacrylic acid and sodium salts thereof, polyacrylates, and metal salts of condensed arylsulphonic acids. Representative examples of commercially available dispersants useful in the present invention include Rhoplex®, Acumer®, and Tamol® available from Rohm & Haas, Acronal® available from BASF and Joncryl® available from Johnson Wax.

The dispersant concentration in the imaging system of the present invention can be varied over a wide range, with the upper limit being determined only by economical and practical considerations based on what properties are desired in the final product. It is preferred that the upper limit be about 10%, more preferably 8%, and most preferably about 5%, by weight of the developer resin. The preferred lower limit is about 0.5%. A more preferred lower limit is about 1.0%, with about 1.5% by weight, based on the total weight of the developer resin, being the most preferred lower limit. The dispersant of the invention is an optional additive and can be used either alone or in combination with other dispersants.

Fillers may be incorporated into the imaging layer of the present invention to improve further the cohesive strength of the coating layer and hence the overall binding capability of the layer within the PET substrates is increased tremendously. Such additives include oxides, carbonates and sulfates of metals such as calcium, aluminum, barium, silicon, magnesium, sodium and mixtures of said oxides, carbonates and sulfates, such as tricalcium aluminate hexahydrate, sodium aluminosilicate, aluminum silicate, calcium silicate, barium sulfates (barytes), clays, talc, micas, and mixtures thereof.

Commercially available fillers useful in the present invention include Diafil® 590 (CR Minerals), Ultrex® 95 (Engelhard), Opti-white (Burgess Inc.), CaCO₃ (OMYA, Inc.), hydrophobic and hydrophilic amorphous silica (Wacker), Zeolex®, and Hysafe® 310 (Huber Corp.).

The present invention may be embodied in other specific forms without departing from the spirit of the essential attributes thereof; therefore, the illustrated embodiment should be considered in all respects as illustrative and not restrictive, reference being made to the appended claims rather than to the foregoing description to indicate the scope of the invention.

1-31. (Cancelled)

32. A multi-lumen catheter assembly comprising:
(a) a multi-lumen tube portion having a proximal end and a distal end;
(b) a distal portion comprising a plurality of distal single-lumen tubes, each distal single-lumen tube having a proximal end and a distal end, the proximal end of each distal single-lumen tube being permanently connected to the distal end of the multi-lumen tube portion such that the lumen of each distal single-lumen tube is in fluid communication with one of the lumens of the multi-lumen tube portion;
(c) a proximal portion comprising a plurality of single-lumen tubes, each proximal single-lumen tube having a distal end and a proximal end, the distal end of each proximal single-lumen tube being permanently connected to the proximal end of the multi-lumen tube portion such that the lumen of each proximal single-lumen tube is in fluid communication with one of the plurality of lumens of the multi-lumen tube portion; and
a plurality of extension members, each extension member configured at a proximal end thereof to be attachable to one of the distal single-lumen tubes and configured at a distal end thereof for connection to a fluid exchange device.

33. The multi-lumen catheter assembly according to claim 32, wherein each lumen of the multi-lumen tube portion is in fluid communication with the lumen of one of the distal single-lumen tubes and the lumen of one of the proximal single-lumen tubes, thereby defining a flow path through the catheter.

34. The multi-lumen catheter assembly according to claim 32, wherein the multi-lumen tube portion includes two lumens, the distal portion includes two distal single-lumen tubes, and the proximal portion includes two proximal single-lumen tubes.

35. The multi-lumen catheter assembly according to claim 34 further comprising a connector adapted to receive and hold the distal ends of the distal single-lumen tubes.

36. The multi-lumen catheter assembly according to claim 35 wherein the connector further comprises means for attaching the connector to a trocar.

37. The multi-lumen catheter assembly according to claim 35 further comprising a sheath that may be disposed over at least a portion of the distal ends of the two distal single-lumen tubes and at least a portion of the connector.

38. The multi-lumen catheter assembly according to claim 32 wherein the multi-lumen tube portion, the distal single-lumen tubes, and the proximal single-lumen tubes are comprised of a fusible material, and the distal single-lumen tubes and proximal single-lumen tubes are respectively fused to the distal and proximal ends of the multi-lumen tube portion.

39. The multi-lumen catheter assembly according to claim 32 wherein the distal single-lumen tubes have a substantially round cross-section over at least a portion of their length.

40. The multi-lumen catheter assembly according to claim 32 wherein the proximal single-lumen tubes have a substantially D-shaped cross-section over at least a portion of their length.

41. The multi-lumen catheter assembly according to claim 32 wherein the distal single-lumen tubes have a substantially round cross-section over at least a portion of their length and the proximal single-lumen tubes have a substantially D-shaped cross-section over at least a portion of their length.

42. The multi-lumen catheter assembly according to claim 32 wherein at least one of the proximal single-lumen tubes is shorter in length than at least one other proximal single-lumen tube.

43. The multi-lumen catheter assembly according to claim 32 further including a stabilizing cuff affixed to an outer portion of the multi-lumen tube.

44. The multi-lumen catheter assembly according to claim 32 wherein the proximal end of each extension member comprises a cannula configured to be inserted into the single-lumen of one of the distal single-lumen tubes.

45. The multi-lumen catheter assembly according to claim 44 wherein each extension member further comprises a mating compression fitting and a tube portion, wherein a proximal end of the mating compression fitting is rigidly attached to the cannula, a distal end of the mating compression fitting is rigidly attached to a proximal end of the tube portion and the mating compression fitting allows fluid communication between the cannula and the tube portion.

46. The multi-lumen catheter assembly according to claim 45 wherein the mating compression fitting further comprises a threaded connection portion adjacent the proximal end thereof and the extension member further comprises a connector hub having a central lumen of a diameter whereby the distal single-lumen tube of the catheter may be slideably received in the central lumen of the connector hub, the connector hub also comprising a connection portion mateable with the threaded connection portion of the mating compression fitting.

47. The multi-lumen catheter assembly according to claim 32, wherein each of the proximal single-lumen tubes includes a tube wall, and each of the proximal single-lumen tubes includes at least one opening extending through its tube wall.

48. The multi-lumen catheter assembly according to claim 32, wherein an external portion of at least one of the distal single-lumen tubes includes indicia, the indicia indicating a discrete flow path through the catheter.

49. The multi-lumen catheter assembly according to claim 32 wherein the proximal single-lumen tubes are two in number and have longitudinal axes which intersect at an included angle in a free state, the included angle being in a range from about 10 degrees to about 30 degrees.

50. A dual-lumen catheter comprising:
(a) a dual-lumen tube portion having a proximal end and a distal end;
(b) a distal portion comprising two distal single-lumen tubes, each distal single-lumen tube having a proximal end and a distal end, the proximal end of each distal single-lumen tube extending from the distal end of the dual-lumen tube portion such that the lumen of each distal single-lumen tube is in fluid communication with one of the lumens of the dual-lumen tube portion; and
(c) a proximal portion comprising two proximal single-lumen tubes, each proximal single-lumen tube having a proximal end and a distal end, the distal end of each proximal single-lumen tube extending from the proximal end of the dual-lumen tube portion such that the lumen of each proximal single-lumen tube is in fluid communication with one of the lumens of the dual-lumen tube portion.

51. The dual-lumen catheter of according to claim 50, wherein the dual-lumen tube portion, the distal single-lumen tubes and the proximal single-lumen tubes are integral with each other.

52. The dual-lumen catheter of according to claim 51, further comprising a plurality of extension members, each extension member configured at a proximal end thereof to be attachable to one of the distal single-lumen tubes and configured at a distal end thereof for connection to a fluid exchange device.

53. The dual-lumen catheter of according to claim 50, further comprising two extension members comprising:
(i) a cannula at the proximal end of the extension member configured to be inserted into and retained by the single-lumen of one of the distal single-lumen tubes;
(ii) a mating compression fitting; and
(iii) a tube portion,
wherein a proximal end of the mating compression fitting is rigidly attached to the cannula, a distal end of the mating compression fitting is rigidly attached to a proximal end of the tube portion and the mating compression fitting allows fluid communication between the cannula and the tube portion.

54. The dual-lumen catheter according to claim 53 wherein a distal end of the tube portion comprises means for connecting the tube portion to a fluid exchange device.

55. The dual-lumen catheter according to claim 53 wherein the mating compression fitting further comprises a threaded connection portion adjacent the proximal end thereof and the extension member further comprises a connector hub having a central lumen of a diameter such that the distal single-lumen tube of the catheter may be slideably received in the central lumen of the connector hub, the connector hub also comprising a connection portion mateable with the threaded connection portion of the mating compression fitting.

56. The dual-lumen catheter according to claim 50 wherein the dual-lumen tube portion, the distal single-lumen tubes, and the proximal single-lumen tubes are comprised of a fusible material, and the distal single-lumen tubes and proximal single-lumen tubes are respectively fused to the distal and proximal ends of the dual-lumen tube portion.

57. The dual-lumen catheter according to claim 50 wherein the distal single-lumen tubes have a substantially round cross-section over at least a portion of their length.

58. The dual-lumen catheter according to claim 57 wherein the at least one of the proximal single-lumen tubes is shorter in length than at least one other proximal single-lumen tube.

59. The dual-lumen catheter according to claim 50 further including a stabilizing cuff affixed to an outer portion of the dual-lumen tube.

60. A multi-lumen catheter comprising:
(a) a multi-lumen tube portion having a proximal end and a distal end;
(b) a distal portion comprising a plurality of distal single-lumen tubes, each distal single-lumen tube having a proximal end and a distal end, the proximal end of each distal single-lumen tube being permanently connected to the distal end of the multi-lumen tube portion such that the lumen of each distal single-lumen tube is in fluid communication with one of the lumens of the multi-lumen tube portion;
(c) a proximal portion comprising a plurality of single-lumen tubes, each proximal single-lumen tube having a distal end and a proximal end, the distal end of each proximal single-lumen tube being permanently connected to the proximal end of the multi-lumen tube portion such that the lumen of each proximal single-lumen tube is in fluid communication with one of the plurality of lumens of the multi-lumen tube portion.
